(19) United States
(12) Patent Application Publication
(10) Pub. No.: US 2008/0088735 A1
(43) Pub. Date: Apr. 17, 2008

(54) Social media platform and method

(76) Inventors: Bryan Biniak, Los Angeles, CA (US); Brock Meltzer, Los Angeles, CA (US); Ata Ivanov, Santa Monica, CA (US)

Correspondence Address: DLA PIPER US LLP, 2000 UNIVERSITY AVENUE, E. PALO ALTO, CA, 94303-2248, US

(21) Appl. No.: 11/540,748

(22) Filed: Sep. 29, 2006

(51) Int. Cl. H04N 11/00; H04N 7/00; H04N 7/16

(52) U.S. Cl. 348/468; 725/135; 348/460

(57) ABSTRACT

A Social Media Platform and method are provided wherein contextual content, in real-time, is delivered to a user along with the original content from which the contextual content is derived.

### FIELD OF THE INVENTION

The invention relates generally to a system and method for creating generative media and content through a Social Media Platform to enable a parallel programming experience to a plurality of users.

### BACKGROUND OF THE INVENTION

The television broadcast experience has not changed dramatically since its introduction in the early 1900s. In particular, live and prerecorded video is transmitted to a device, such as a television, liquid crystal display device, computer monitor and the like, while viewers passively engage.

With broadband Internet adoption and mobile data services hitting critical mass, television is at a cross roads faced with:
Declining Viewership
Degraded Ad Recognition
Declining Ad Rates & Spend
Audience Sprawl
Diversionary Channel Surfing
Imprecise and Impersonal Audience Measurement Tools
Absence of Response Mechanism
Increased Production Costs

In addition, there is a tremendous increase in the number of people that have high speed (cable model, DSL, broadband, etc.) access to the internet so that it is easier for people to download content from the internet. There has also been a trend in which people are accessing the Internet while watching television. Thus, it is desirable to provide a parallel programming experience that is a reinvigorated version of the current television broadcast experience that incorporates new Internet based content.

### BRIEF DESCRIPTION OF THE DRAWINGS

FIG. 1 illustrates the high level flow of information and content through the Social Media Platform;

FIG. 2 illustrates the content flow and the creation of generative media via a Social Media Platform;

FIG. 3 illustrates the detailed platform architecture components of the Social Media Platform for creation of generative media and parallel programming shown in FIG. 2; and

FIGS. 4-6 illustrate an example of the user interface for an implementation of the Social Media Platform and the Parallel Programming experience.

### DETAILED DESCRIPTION OF AN EMBODIMENT

The invention is particularly applicable to a Social Media Platform in which the source of the original content is a broadcast television signal and it is in this context that the invention will be described. It will be appreciated, however, that the system and method has greater utility since it can be used with a plurality of different types of original source content.

The ecosystem of the Social Media Platform may include primary sources of media, generative media, participatory media, generative programming, parallel programming, and accessory devices. The Social Media Platform uses the different sources of original content to create generative media, which is made available through generative programming and parallel programming (when published in parallel with the primary source of original content). The generative media may be any media connected to a network that is generated based on the media coming from the primary sources. The generative programming is the way the generative media is exposed for consumption by an internal or external system. The parallel programming is achieved when the generative programming is contextually synchronized and published in parallel with the transmitted media (source of original content). The participatory media means that third parties can produce generative media, which can be contextually linked and tuned with the transmitted media. The accessory devices of the Social Media Platform and the parallel programming experience may include desktop or laptop PCs, mobile phones, PDAs, wireless email devices, handheld gaming units and/or PocketPCs that are the new remote controls.

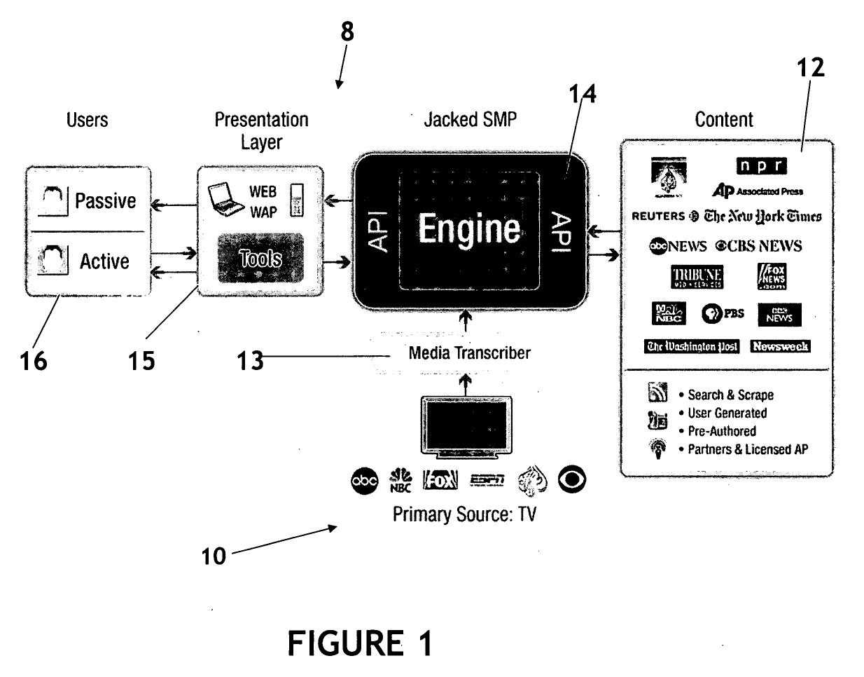

FIG. 1 illustrates the high level flow of information and content through the Social Media Platform 8. The platform may include an original content source 10, such as a television broadcast, with a contextual content source 12, that contains different content wherein the content from the original content source is synchronized with the content from the contextual content source so that the user views the original content source while being provided with the additional content contextually relevant to the original content in real time.

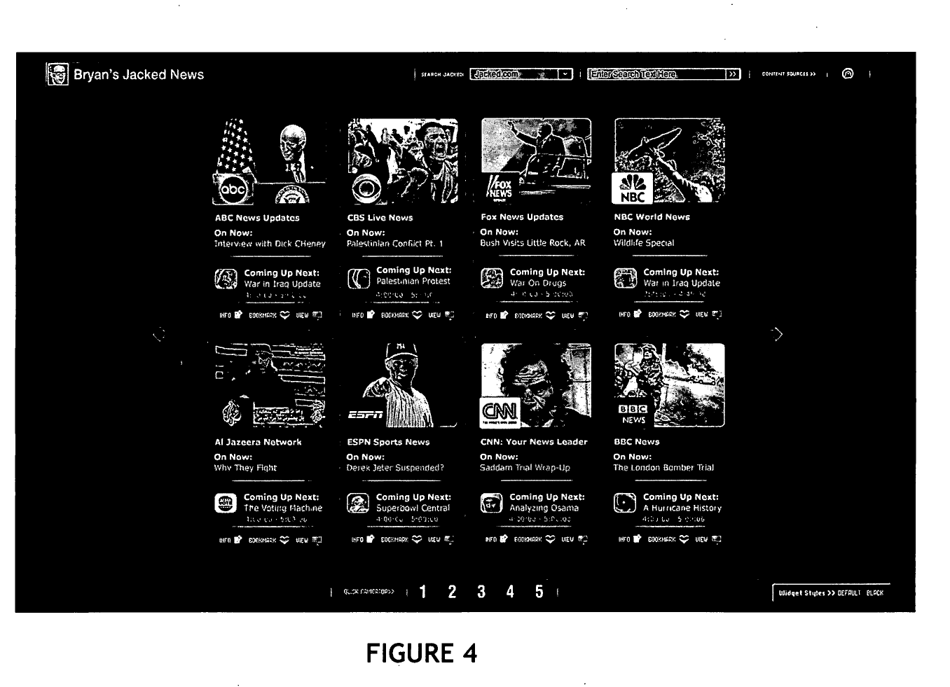

The contextual content source 12 may include different types of contextual media including text, images, audio, video, advertising, commerce (purchasing) as well as third party content such as publisher content (such as Time, Inc., XML), web content, consumer content, advertiser content and retail content. An example of an embodiment of the user interface of the contextual content source is described below with reference to FIGS. 4-6. The contextual content source 12 may be generated/provided using various techniques such as search and scrape, user generated, pre-authored and partner and licensed material.

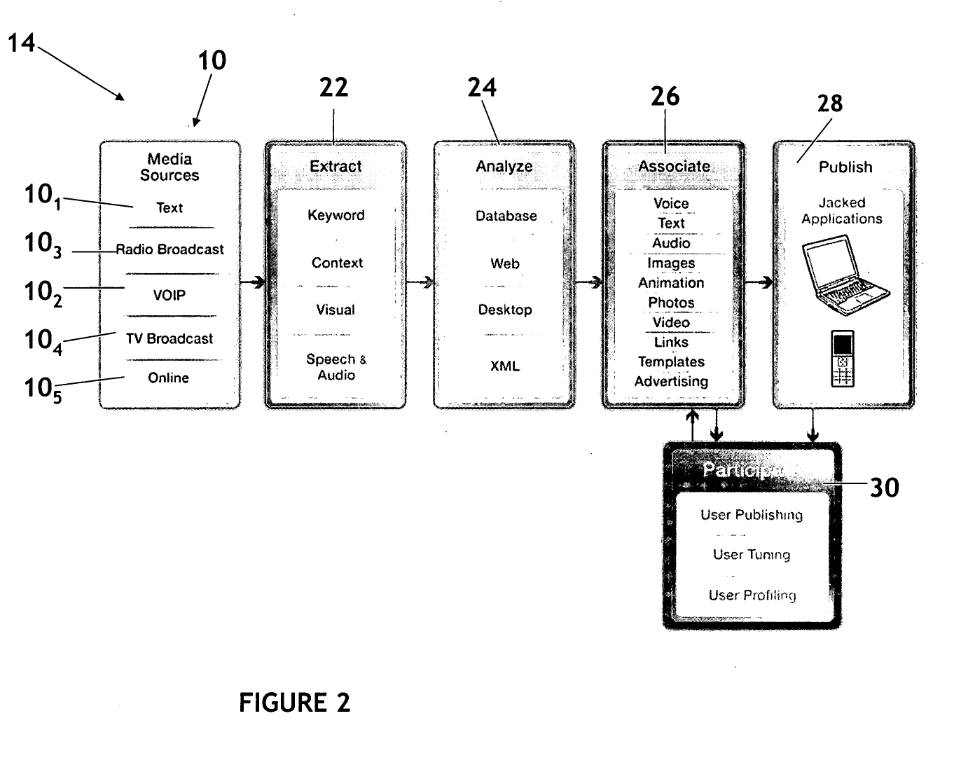

The original/primary content source 10 is fed into a media transcriber 13 that extracts information from the original content source which is fed into a social media platform 14 that contains an engine and an API for the contextual content and the users. The Social Media Platform 14 at that point extracts, analyzes, and associates the Generative Media (shown in more detail in FIG. 2) with content from various sources. Contextually relevant content is then published via a presentation layer 15 to end users 16 wherein the end users may be passive and/or active users. The passive users will view the original content in synchronization with the contextual content while the active users will use tools made accessible to the user to tune content, create and publish widgets, and create and publish dashboards. The users may use one device to view both the original content and the contextual content (such as television in one embodiment) or use different devices to view the original content and the contextual content (such as on a web page as shown in the examples below of the user interface).

The social media platform uses linear broadcast programming (the original content) to generate participative, parallel programming (the contextual/secondary content) wherein the original content and secondary content may be synchronized and delivered to the user. The social media platform enables viewers to jack-in into broadcasts to tune and publish their own content. The social media platform also extends the reach of advertising and integrates communication, community and commerce together.

FIG. 2 illustrates content flow and creation of generative media via a Social Media Platform 14. The system 14 includes the original content source 10 and the contextual/secondary content source 12 shown in FIG. 1. As shown in FIG. 2, the original content source 10 may include, but is not limited to, a text source 10₁, such as Instant Messaging (IM), SMS, a blog or an email, a voice over IP source 10₂, a radio broadcast source 10₃, a television broadcast source 10₄ or a online broadcast source 10₅, such as a streamed broadcast. Other types of original content sources may also be used (even those yet to be developed original content sources) and those other original content sources are within the scope of the invention since the invention can be used with any original content source as will be understood by one of ordinary skill in the art. The original content may be transmitted to a user over various medium, such as over a cable, and displayed on various devices, such as a television attached to the cable, since the system is not limited to any particular transmission medium or display device for the original content. The secondary source 12 may be used to create contextually relevant generative content that is transmitted to and displayed on a device 28 wherein the device may be any processing unit based device with sufficient processing power, memory and connectivity to receive the contextual content. For example, the device 28 may be a personal computer or a mobile phone (as shown in FIG. 2), but the device may also be PDAs, laptops, wireless email devices, handheld gaming units and/or PocketPCs. The invention is also not limited to any particular device on which the contextual content is displayed.

The social media platform 14, in this embodiment, may be a computer implemented system that has one or more units (on the same computer resources such as servers or spread across a plurality of computer resources) that provide the functionality of the system wherein each unit may have a plurality of lines of computer code executed by the computer resource on which the unit is located that implement the processes and steps and functions described below in more detail. The social media platform 14 may capture data from the original content source and analyze the captured data to determine the context/subject matter of the original content, associate the data with one or more pieces of contextual data that is relevant to the original content based on the determined context/subject matter of the original content and provide the one or more pieces of contextual data to the user synchronized with the original content. The social media platform 14 may include an extract unit 22 that performs extraction functions and steps, an analyze unit 24 that performs an analysis of the extracted data from the original source, an associate unit 26 that associates contextual content with the original content based on the analysis, a publishing unit 28 that publishes the contextual content in synchronism with the original content and a participatory unit 30. The extraction unit 22 captures the digital data from the original content source 10 and extracts or determines information about the original content based on an analysis of the original content. The analysis may occur through keyword analysis, context analysis, visual analysis and speech/audio recognition analysis. For example, the digital data from the original content may include close captioning information or metadata associated with the original content that can be analyzed for keywords and context to determine the subject matter of the original content. As another example, the image information in the original content can be analyzed by a computer, such as by video optical character recognition to text conversion, to generate information about the subject matter of the original content. Similarly, the audio portion of the original content can be converted using speech/audio recognition to obtain textual representation of the audio. The extracted closed captioning and other textual data is fed to an analysis component which is responsible for extracting the topic and the meaning of the context. The extract unit 22 may also include a mechanism to address an absence or lack of close caption data in the original content and/or a mechanism for addressing too much data that may be known as “informational noise.”

Once the keywords/subject matter/context of the original content is determined, that information is fed into the analyze unit 24 which may include a contextual search unit. The analysis unit 24 may perform one or more searches, such as database searches, web searches, desktop searches and/or XML searches, to identify contextual content in real time that is relevant to the particular subject matter of the original content at the particular time. The resultant contextual content, also called generative media, is then fed into the association unit 26 which generates the real-time contextual data for the original content at that particular time. As shown in FIG. 2, the contextual data may include, for example, voice data, text data, audio data, image data, animation data, photos, video data, links and hyperlinks, templates and/or advertising.

The participatory unit 30 may be used to add other third party/user contextual data into the association unit 26. The participatory contextual data may include user publishing information (information/content generated by the user or a third party), user tuning (permitting the user to tune the contextual data sent to the user) and user profiling (that permits the user to create a profile that will affect the contextual data sent to the user). An example of the user publishing information may be a voiceover of the user which is then played over the muted original content. For example, a user who is a baseball fan might do the play-by-play for a game and then play his play-by-play while the game is being played wherein the audio of the original announcer is muted which may be known as fan casting.

The publishing unit 28 may receive data from the association unit 26 and interact with the participatory unit 30. The publishing unit 28 may publish the contextual data into one or more formats that may include, for example, a proprietary application format, a PC format (including for example a website, a widget, a toolbar, an IM plug-in or a media player plug-in) or a mobile device format (including for example WAP format, JAVA format or the BREW format). The formatted contextual data is then provided, in real time and in synchronization with the original content, to the devices 16 that display the contextual content.

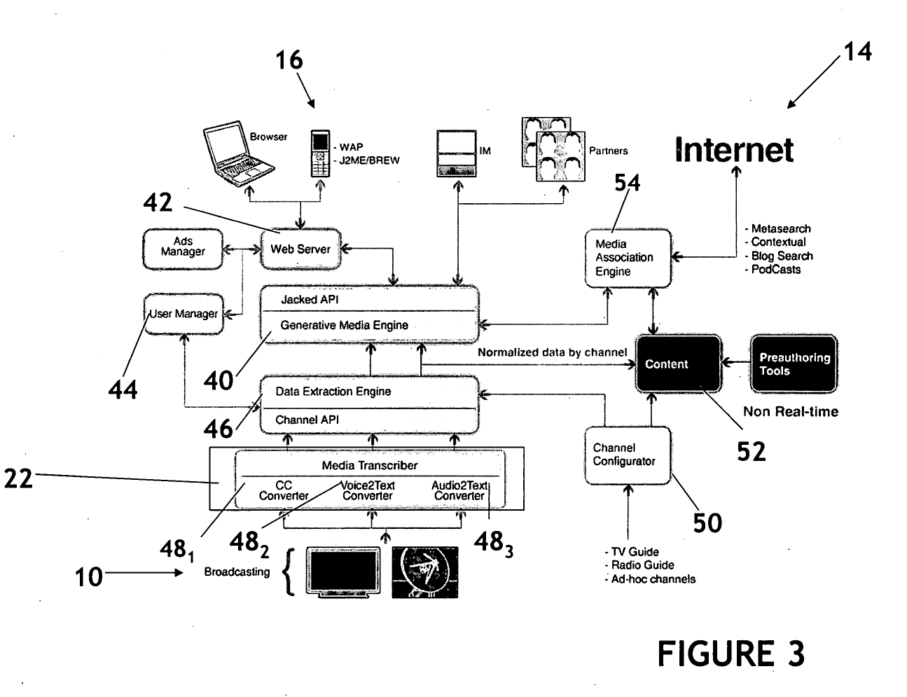

FIG. 3 illustrates more details of the Social Media Platform for creation of generative media and parallel programming shown in FIG. 2 with the original content source 10, the devices 16 and the social media platform 14. The platform may further include a Generative Media engine 40 (that contains a portion of the extract unit 22, the analysis unit 24, the associate unit 26, the publishing unit 28 and the participatory unit 30 shown in FIG. 2) that includes an API wherein the IM users and partners can communicate with the engine 40 through the API. The devices 16 communicate with the API through a well known web server 42. A user manager unit 44 is coupled to the web server to store user data information and tune the contextual content being delivered to each user through the web server 42. The platform 14 may further include a data processing engine 46 that generates normalized data by channel (the channels are the different types of the original content) and the data is fed into the engine 40 that generates the contextual content and delivers it to the users. The data processing engine 46 has an API that receives data from a close captioning converter unit 48₁ (that analyzes the close captioning of the original content), a voice to text converter unit 48₂ (that converts the voice of the original content into text) so that the contextual search can be performed and an audio to text converter unit 48₃ (that converts the voice of the original content into text) so that the contextual search can be performed wherein each of these units is part of the extract unit 22. The close captioning converter unit 48₁ may also perform filtering of “dirty” close captioning data such as close captioning data with misspellings, missing words, out of order words, grammatical issues, punctuation issues and the like. The data processing engine 46 also receives input from a channel configurator 50 that configures the content for each different type of content. The data from the original content and the data processed by the data processing engine 46 are stored in a data storage unit 52 that may be a database. The database also stores the channel configuration information, content from the preauthoring tools (which is not in realtime) and search results from a search coordination engine 54 used for the contextual content. The search coordination engine 54 (part of the analysis unit 24 in FIG. 2) coordinates the one or more searches used to identify the contextual content wherein the searches may include a metasearch, a contextual search, a blog search and a podcast search.

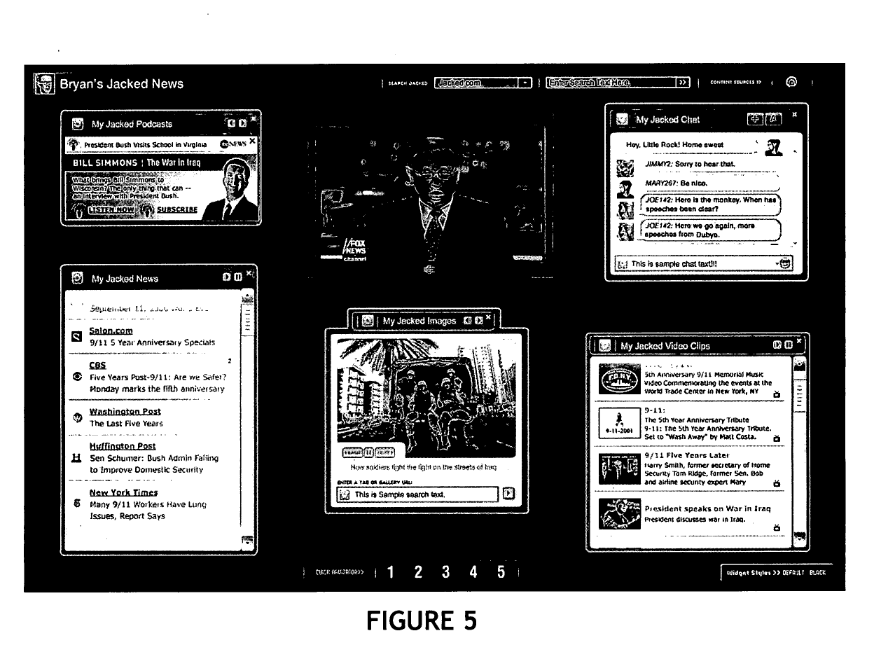

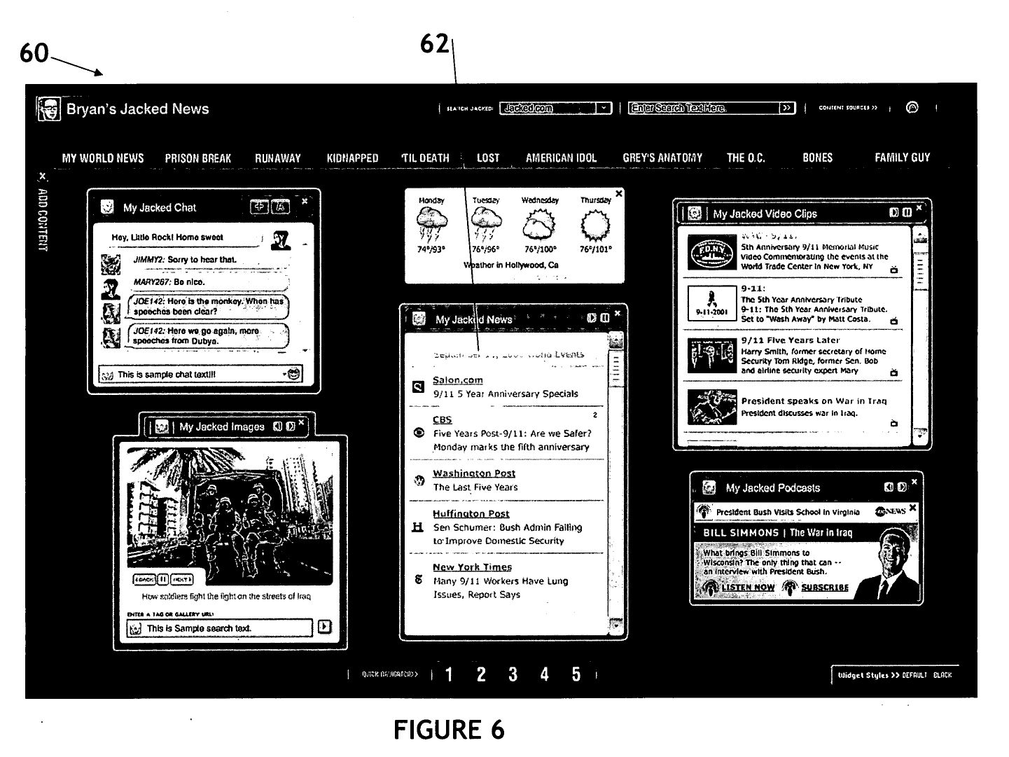

FIGS. 4-6 illustrate an example of the user interface for an implementation of the Social Media Platform. For example, when a user goes to Jacked.com, the user interface shown in FIG. 4 is displayed. In this user interface, a plurality of channels (such as Fox News, BBC News, CNN Breaking News) are shown wherein each channel displays content from the particular channel. When a user selects the Fox News channel, the user interface shown in FIG. 5 is displayed to the user which has the Fox News content (the original content) in a window along with one or more contextual windows that display the contextual data that is related to what is being shown in the original content. In this example, the contextual data may include image slideshows, instant messaging content, RSS text feeds, podcasts/audio and video content. The contextual data shown in FIG. 5 is generated in realtime by the Generative Media engine 40 based on the original content capture and analysis so that the contextual data is synchronized with the original content. FIG. 6 shows an example of the webpage 60 with a plurality of widgets (such as a “My Jacked News” widget 62, “My Jacked Images” widget, etc.) wherein each widget displays contextual data about a particular topic without the original content source being shown on the same webpage.

While the foregoing has been with reference to a particular embodiment of the invention, it will be appreciated by those skilled in the art that changes in this embodiment may be made without departing from the principles and spirit of the invention, the scope of which is defined by the appended claims.

1. A media delivery system, comprising:
at least one original content source having a piece of subject matter information;
a social media platform, coupled to the at least one original content source, that generates at least original content specific piece of contextual data wherein the original content specific contextual data is generated based on the piece of subject matter information in the original content; and
a device, in periodic communication with the social media platform, to which the original content specific contextual data is delivered in real-time while the original content is being delivered to the user.

2. The system of claim 1, wherein the piece of subject matter information further comprises close captioning data and wherein the social media platform further comprises a close captioning unit that captures the close captioning data and determines the piece of original content specific contextual data based on the close captioning data.

3. The system of claim 1, wherein the piece of subject matter information further comprises audio data and wherein the social media platform further comprises an audio to text conversion unit that captures the audio data and converts the audio data to text data and determines the piece of original content specific contextual data based on the text data.

4. The system of the claim 1, wherein the social media platform further comprises an extract unit that extracts the piece of subject matter information in the original content, an analyze unit that searches for the contextual data to generate a set of found contextual data, and associate unit that associates one or more pieces of the set of found contextual data with the original content based on the piece of subject matter information in the original content and a publish unit that publishes the original content specific contextual data to the device.

5. The system of claim 4, wherein the social media platform further comprises a participate unit that permits a user to participate in the generation of the contextual data.

6. The system of claim 4, wherein the participate unit further comprises a user publishing unit that permits the user to publish contextual data, a user tuning unit that permits the user to tune the contextual data to the user.

7. The system of claim 4, wherein the extract unit further comprises a data processing engine that processes each type of original content based on input from a channel configurator.

8. The system of claim 1, wherein the contextual data further comprises one or more of voice, text, audio, images, animation, photos, videos, links; templates and advertising.

9. The system of claim 8, wherein the original content is broadcast television broadcast over a television delivery medium to a viewing device.

10. The system of claim 9, wherein the device further comprises one of a laptop, a PDA, a PC, a mobile phone, a wireless email device, a handheld gaming units and a PocketPC.

11. The system of claim 8, wherein the original content further comprises one of online content, text content, voice over IP content and radio broadcast content.

12. The system of claim 11, wherein the device further comprises one of a laptop, a PDA, a PC, a mobile phone, a wireless email device, a handheld gaming units and a PocketPC.

13. A media delivery method using a social media platform, the method comprising:
receiving at least one original content source having a piece of subject matter information;
extracting the piece of subject matter information from the original content;
locating one or more pieces of contextual content;
generating an original content specific piece of contextual content from the one or more pieces of contextual content based on the piece of subject matter information in the original content; and
synchronizing the delivery of the original content specific piece of contextual content to the user while the original content is being delivered to the user.

14. The method of claim 13, wherein the piece of subject matter information further comprises close captioning data and wherein extracting the piece of subject matter information further comprises capturing the close captioning data and determining the piece of original content specific contextual data based on the close captioning data.

15. The method of claim 13, wherein the piece of subject matter information further comprises audio data and wherein extracting the piece of subject matter information further comprises converting the audio data to text data and determining the piece of original content specific contextual data based on the text data.

16. The method of claim 13 further comprising permitting a user to participate in the generation of the contextual content.

17. The method of claim 16, wherein permitting a user to participate further comprises permitting the user to publish contextual data and permitting the user to tune the contextual data to the user.

18. The method of claim 13, wherein the contextual data further comprises one or more of voice, text, audio, images, animation, photos, videos, links, templates and advertising.

19. The method of claim 18, wherein the original content is broadcast television broadcast over a television delivery medium to a viewing device.

20. The method of claim 19, wherein the device further comprises one of a laptop, a PDA, a PC, a mobile phone, a wireless email device, a handheld gaming units and a PocketPC.

21. The method of claim 18, wherein the original content further comprises one of online content, text content, voice over IP content and radio broadcast content.

22. The method of claim 21, wherein the device further comprises one of a laptop, a PDA, a PC, a mobile phone, a wireless email device, a handheld gaming units and a PocketPC.
